(19) United States
(12) Patent Application Publication
(10) Pub. No.: US 2010/0110439 A1
(43) Pub. Date: May 6, 2010

(54) OPTICAL MEASURING INSTRUMENT

(76) Inventors: Roman Gruler, Rotweil (DE); Konrad Faulstich, Salem-Neufrach (DE)

Correspondence Address: SHLESINGER, ARKWRIGHT & GARVEY LLP, 5845 Richmond Highway, Suite 415, ALEXANDRIA, VA, 22303, US

(21) Appl. No.: 12/449,649

(22) PCT Filed: Feb. 25, 2008
(86) PCT No.: PCT/EP2008/001468

§ 371 Date: Jan. 13, 2010

(30) Foreign Application Priority Data
Feb. 23, 2007 (EP) 07003808.8

(51) Int. Cl. G01N 21/01; G01N 1/10; G01N 21/55; G01T 1/10

(52) U.S. Cl. 356/440; 356/246; 356/445; 250/459.1

(57) ABSTRACT

The invention provides for an optical measuring instrument and measuring device. The optical measuring instrument for investigating a specimen contained in a sample comprises at least one source for providing at least one electromagnetic beam intended to irradiate the sample and to interact with the specimen within the sample, at least one sensor for detecting an output of the interaction between the specimen and the electromagnetic beam, an integrally formed mechanical bench for the optical and electronic components, a sample holder for holding the sample, wherein the at least one source, the at least one sensor, and the mechanical bench are integrated in one monolithic optoelectronic module and the sample holder can be connected to this module.

### FIELD OF THE INVENTION

The present invention relates to an optical measuring instrument and an optical measuring device. Furthermore, the invention provides for a method for performing an optical measurement and a computer program for carrying out this method.

### DESCRIPTION OF THE RELATED ART

Optical measuring instruments and methods for performing an optical measurement are known.

Lateral Flow Immunoassays as an example for an optical measurement technique have become invaluable tools for various diagnostics applications in the past. Among the most prominent reasons for this development are that these tools demonstrate reasonable sensitivity and specificity for many applications and provide fast time to result since they are applied to the sample directly often without the need of prior time-consuming sample preparation steps. Lateral Flow Immunoassays are easy to operate and last but not least they do not require a device for read-out, therefore they are cheap and mobile.

However, as every technology, lateral flow immunoassays also have limitations and do lack important features to further exploit this technology. Those are mainly lack of automated documentation, subjective interpretation of results leading to a high number of false positives and false negatives, lack of accurate quantitation and limited multiplexing capabilities as well as limitation in high throughput diagnostics due to manual operation. Sensitivity is limited by the Kd of the Antibody-Antigen conjugate and by the colorimetric read out using gold beads in current technology. Also specificity is influenced by the cross-reactivity of antibodies and limits the applicability to good and stable compounds.

Last but not least, companies are eager to distinguish themselves from rivals in this highly competitive industry and to offer higher quality products combined with more convenience to the customer. To overcome some of the limitations both devices as well as novel biochemical techniques are currently being developed.

Due to the high demand, the low number of affordable and high performance lateral flow immunoassay devices both for lab and field based tests is surprising: Although lateral flow immunoassays are very affordable since the read out can be performed visually without devices in Gold or Latex Bead based assays, inconvenience in manual documentation and subjective interpretation of results often leading to false negative and false positive results have created high demand for automated systems.

However, these systems need to fulfill the features requested by the customers and be compatible with advantages of the lateral flow technology. These are in first order their mobility, simplicity of operation, speed, low cost and the avoidance of time consuming sample preparation steps. Additionally the trend is strongly pointing towards improvement in sensitivity by replacing Gold Beads with fluorescence dyes. Fluorescence dyes cannot be read out by eye directly, which is creating demand for readers. The same applies for paramagnetic particle based lateral flow immunoassays.

Just very recently several devices became commercially available and can be grouped into colorimetric, fluorescence and magnetic readers: Also CCD based imaging systems and scanning systems can be distinguished.

Known devices for lateral flow immunoassays are often CCD based systems attached to a palm or pocket PC. However, there are limitations regarding the miniaturization of CCD based systems as the camera needs a certain field of view to capture the image from the entire strip. The most important point to consider might be the price sensitivity of the lateral flow market.

Furthermore, the number of data points that need to be recorded in CCD based systems is very high, especially when a reasonable resolution is required. This may result in very limited internal memory capacity or is accordingly expensive. Additionally, a computer is always required.

Scanning systems on the other hand have the advantage that the scans are performed very rapidly including data evaluation. No imaging software and processes need to be performed, memory size can be much smaller and more scans can be stored on the device directly. This opens the possibility to operate and perform tests completely independent of any connections to computers and provides therefore a simple solution to field based tests and truly handheld devices. This feature may also find its expression in the price. Customers do have the option however to connect those devices to a computer for further data storage and analysis.

The disadvantage of scanning systems is however, that it is harder to scan the entire strip and no image of the test strip will be available. The data look different as the images the customer is used to from visual read out. In most cases however, customers request a data output in the format yes/no, positive/negative or even a recommended action. The recording of an image is seen only as an intermediate step. Another disadvantage of scanning systems are their moving parts, which may be subject to failure particularly over longer life-times.

In addition, luminescence, e.g. fluorescence, has long been established as an important tool in biology, clinical diagnostics and cellular research. More recently the market has moved towards the use of mobile instrumentation away from the traditional laboratory environment. The simplest example of this is in point-of-care diagnostics, where there is a clear paradigma shift away from centralised testing laboratories towards localised diagnostics

Furthermore, emergency diagnostics, epidemiological preparedness and the high cost of the Health Care System have pushed demand for affordable and mobile point of care devices with highest sensitivity, specificity and short time to result.

Often time-to-result is counted from the arrival of samples in the laboratory. A more realistic view however is to consider the full workflow of which the assay test procedure is only a small part: This is sample collection, sample storage, sample transportation, sample preparation, assay test, documentation of data, interpretation of data and data communication. This view is particularly important if the samples are collected in the field.

EP 0 088 636 discloses a method and apparatus for the quantitative determination of an analyte in a liquid. The apparatus employs a liquid-permeable solid medium defining a liquid flow path. The medium includes a number of reactant-containing reaction zones spaced apart along the flow path and in which reaction occurs with the analyte to result in the formation of a predetermined product. The product can be detected and the number of reaction zones in which such detection occurs indicating quantitatively the amount of analyte in said fluid.

U.S. Pat. No. 6,611,326 discloses a system and apparatus for evaluating the effectiveness of waver drying techniques, wherein a laser directs lager energy through a partial reflector, a dichroic mirror, and a focusing lens before the laser energy is received on a patterned surface of the wafer and the reflected laser energy and the fluorescent energy emanating from the surface of the wafer return through the focusing lens to the dichroic mirror through which the laser energy passes, the reflected laser energy continuing to the partial reflector.

EP 1 550 872 A2 discloses a lateral flow quantitative assay method and strip, a laser-induced epifluorescence detection device and a small scanner therfor. The scanner is integrated with a detection device into a single body. The components of the detection device are arranged in a structure such that the laser is passed through an exciter filter. The small scanner allows the detection device to determine an amount of an analyte in a sample by comparing a fluorescence intensity of a triple analyte conjugate with a reference fluorescence intensity of a reference conjugate.

### SUMMARY OF THE INVENTION

In contrast thereto, the invention proposes an optical measuring instrument for investigating a specimen contained in a sample, comprising at least one source for providing at least one electromagnetic beam intended to irradiate the sample and to interact with the specimen within the sample, at least one sensor for detecting an output of the interaction between the specimen and the electromagnetic beam, an integrally formed mechanical bench for the optical and electronic components, and a sample holder for holding the sample, wherein the at least one source, the at least one sensor, and the mechanical bench are integrated in one monolithic optoelectronic module and the sample holder can be connected to this module.

The mechanical bench made from one piece carries all necessary optical and electronic elements including among others the said source and the said sensor forming one monolithic optoelectronic module.

Therefore, a monolithic measuring instrument is provided which includes all necessary parts mounted onto a rigid and miniaturised bench made from one piece, whereby monolithic means that the optoelectronic module, once equipped with the necessary parts, establishes a compact selfconsistent unit adapted for all optical and electronic functions it is supposed to perform and which can be connected to the sample holder, possibly for samples of varying formats.

The output comprises at least one output signal. The output signal(s) can be optical, acoustical and/or opto-acoustical signals.

The mechanical bench can be a uniform block built by an injection moulding process.

Furthermore, the mechanical bench allows for secure and exact positioning of various optical components such as filters and mirrors. Thereby, the optical and electronic components can be replaced easily. The optical components can be filters and mirrors. The electronic components perform among others the signal processing. Alternatively, the optical and electronic components can be permanently mounted in the module.

According to a feature the at least one source and the at least one sensor are arranged such that a confocal measurement can be performed. A confocal measurement means that the focus of the illumination optics or the source, respectively intrinsically is the same as the focus of the detection optics or sensor, respectively. The special construction of the monolithic module predefines the focus of the illumination optics and the focus of the detection optics to be the same in three dimensions.

The confocal measurement does not provide for a high depth of focus but a high sensitivity together with low background noise. Furthermore, the confocal measurement is insensitive to the distance between sample and optics.

According to a further feature the monolithic electrooptical module comprises an interface for connecting sample holders of different types for various sample formats. The samples can be liquid, solid or gel-like.

Sample formats for liquid samples include but are not limited to single wells; multiple wells, wells in a microtiterplate format, tubes and vials, pipes and capillaries, cavities, holes and through holes, cuvettes, flow through cuvettes and flow through cells, biological vessels and cells, vessels and cells implanted in living organisms, droplets, jets and interrupted jets, reaction vessels and fermenters, microfluidic channels, vessels or cavities independent from their actual size and shape; liquids in volumes indefinitely larger than the volume irradiated by the measuring instrument; liquid sample formats in the volume range from below nanoliters to milliliters and liters, but not excluding much smaller or larger volumes.

Sample formats for solid samples include but are not limited to: surfaces; three dimensional surfaces such as porous surfaces; chromatographic stationary materials; membranes, filter and filterlike materials; chromatographic stationary materials, membranes, filter or filterlike material contained in a flow through device or in a laminar flow device; chemo- or biosensor surfaces; light guiding surfaces; nanostructured surfaces; particles in the mm to pm range, particles in the nm range; printed or otherwise deposited solid material on surfaces e.g. as single spots or multitudes of spots; arrays of such spots; so called micro arrays or chips; samples intrinsically containing detectable specimens or samples deliberately doped with detectable specimens; solid material in constant or transient contact with stationary or flowing liquid; fibers and/or fiberlike materials such as fiberlike capillaries, hallow fibers, unfilled or filled with liquid, gel-like or solid material, presented radially or axially; fibers and/or fiberlike materials contained in vessels; fibers and/or fiberlike materials surounded by liquids of all volumes; fibers used as probes in gas, liquid and/or solid materials and/or in vacuum; solid sample sizes varying from sub-micrometer range to centimeters and meters, but not excluding sample formats of much smaller or larger dimensions.

Sample formats for samples showing a gel characteristic include but are not limited to: one-, two- or three-dimensional gel beds as for example used to separate specimens: chromatographic gels (one, two or three dimensional); capillaries; microfluidic channels, vessels and cavities independent from their actual size and shape; solid materials changing its character before, during or after the measuring process into gel-like material; liquid materials changing its character before, during or after the measuring process into gel-like material; gels in constant or transient contact with liquids; gels in volumes indefinitely bigger then the volume irradiated by the measuring instrument; gel volumes from below nanoliters to several milliliters or liters, but not excluding sampie formats of much smaller or larger volumes.

According to an embodiment the source is a light emitting diode. Alternatively, the source can be a laser or a laser diode.

In an embodiment of the instrument according to the invention the sensor is a charge-coupled device. Alternatively, the sensor can be a photo diode or a CMOS transistor. Generally, the sensor can be any kind of light sensitive optoelectronic component, e.g an avalanche type photo diode, a photomultiplier, etc.

According to a feature at least one filter is provided within the module.

In an embodiment of the instrument according to the invention at least one monitor element, e.g. a monitor diode, is provided.

Furthermore, electronic and optoelectronic components can be integrated in the module.

According to a further feature an electronic storage element such as an EEPROM is integrated in the module. This storage element can contain programs and key data such as device specific calibration data enabling a signal processing to be performed together with the measurement. Therefore, an electronic computing unit can be provided for preparing the measurement and ascertaining and processing the results of the measurement. This electronic computing unit can be integrated in the module.

The instrument according to the invention can be a hand-held instrument.

Furthermore, the invention provides for an optical measuring device for investigating a specimen contained in a sample, comprising at least one source for providing at least one electromagnetic beam intended to irradiate the sample and to interact with the specimen within the sample, at least one sensor for detecting an output of the interaction between the specimen and the electromagnetic beam, an integrally formed mechanical bench for the optical and electronic components, wherein the at least one source, the at least one sensor, and the mechanical bench are integrated in one monolithic optoelectronic module.

The mechanical bench as the main part of the device according to the invention is made from one piece and carries all necessary optical and electronic elements including among others the said source and the said sensor forming one monolithic optoelectronic module.

Therefore, a monolithic measuring device is provided which includes all necessary parts mounted onto a rigid and miniaturised bench made from one piece, whereby monolithic means that the optoelectronic module, once equipped with the necessary parts, establishes a compact selfconsistent unit adapted for all optical and electronic functions it is supposed to perform and which can be connected to the sample holder, possibly for samples of varying formats.

Since the device according to the invention is stackable, a number of such devices can be stacked forming a measuring unit for the simultaneous measurement of a multitude of samples. This feature is made possible due to the compact dimensions of the device. The width of the device can be in the range of 10 mm to 8 mm.

The output comprises at least one output signal. The output signal(s) can be optical, acoustical and/or opto-acoustical signals.

The mechanical bench can be a uniform block built by an injection moulding process.

Furthermore, the mechanical bench allows for secure and exact positioning of various optical components such as filters and mirrors. Thereby, the optical and electronic components can be replaced easily. Alternatively, the optical and electronic components can be permanently mounted in the module. The optical components can be filters and mirrors. The electronic components perform among others the signal processing.

According to a feature the at least one source and the at least one sensor are arranged such that a confocal measurement can be performed.

According to a further feature the module comprises an interface such that the module is connectable to sample holders of different types for various sample formats.

In an embodiment of the device according to the invention the source is a light emitting diode. Alternatively, the source can be a laser or a laser diode.

In an embodiment of the device according to the invention the sensor is a charge-coupled device. Alternatively, the sensor can be a photo diode or a CMOS transistor. Generally, the sensor can be any kind of light sensitive optoelectronic component, e.g an avalanche type photo diode, a photomultiplier, etc.

According to a feature at least one filter is provided within the module.

In an embodiment of the instrument according to the invention at least one monitor element, e.g. a monitor diode, is provided.

Furthermore, electronic and optoelectronic components can be integrated in the module.

According to a further feature an electronic storage element such as an EEPROM is integrated in the module. This storage element can contain programs and key data such as device specific calibration data enabling a signal processing to be performed together with the measurement. Therefore, an electronic computing unit can be provided for preparing the measurement and ascertaining and processing the results of the measurement. This electronic computing unit can be integrated in the module.

A method for performing an optical measurement uses an optical measurement device according to one of claims 13 to 23, wherein an electromagnetic beam is emitted by the source to the sample and interacts with the specimen within the sample and an output of this interaction is detected by the sensor.

In an embodiment of the method according to the invention the at least one source and the sensor are arranged such that a confocal measurement is performed.

The sample can be moved relatively to the module and/or the module can be moved relatively to the sample. In case that several samples are provided for the measurement, said samples can be moved relatively to the module and vice versa. The samples can be arranged in a microarray. The relative movement can be oriented in any directions within various coordinate systems.

According to the invention a luminescence measurement such as a fluorescence measurement and/or a reflection measurement and/or an absorption measurement and/or a densitometric measurement can be performed.

Alternatively or additionally, a refractometric and/or a reflectometric measurement can be performed.

The method according to the invention allows a two-dimensional scanning of the sample to be performed. In practice the module can scan the sample by relativ movement between the sample and the module to find a maximum in output and continue the measurement in this maximum point performing a two-dimensional measurement followed by integration of the outputs in this maximum.

Furthermore, at least one filter as an optical component can be provided within the module for determining wavelengths to be used. Additionally, different optical components such as beam shapers and mirrors can be provided.

Furthermore, the focal distance, i.e. the distance between module and sample, can be varied.

The results of the measurements can be displayed and/or audibly reproduced. Furthermore, the results can be sent via common electronic interfaces and data lines such as USB, RS232 or FireWire and via a wireless transmission system such as IR-transmission, Bluetooth, GSM, GPRS, RSID, etc.

Programming, reprogramming, calibration, and recalibration as well as system diagnosis of the device is possible via common electronic interfaces and data lines such as USB, RS232 or FireWire and via a wireless transmission system such as IR-transmission, Bluetooth, GSM, GPRS, RSID, etc.

Furthermore, an ambient light compensation can be carried out.

According to a feature of the method according to the invention the specimen is contained within a liquid.

Alternatively, the specimen can be contained within a solid or a gel.

In further aspect of the invention the specimen is contained within a droplet.

This droplet or a series of droplets containing the specimen can be hold by means of a pipette.

The droplet can be let fall free and thus passes the electromagnetic beam emitted by the source. Alternatively a liquid jet or an interrupted liquid jet can be the medium containing the specimen to be investigated.

In an embodiment of the method according to the invention a calibration is periodically performed.

The proposed instrument and device can be used in nucleic acid diagnostics. Hereby, the invention can be used for any kind of immunoassays, clinical, medical, veterinary, and plant diagnostics, Point-of-Care/Test Analysis, environmental and food/feed analysis, analysis of pharmaceuticals and their metabolites, and/or for brand security testing. It should be noted that the examples are given only by way of illustration and the invention is not limited to the examples above.

The computer program according to the invention with program coding means is designed to perform all the steps of a process according to one of claims 15 to 30, when the computer program is run on a computer or a corresponding computing unit. This computing unit can be integrated within the module.

The computer program with program coding means which are stored on a computer-readable data carrier is designed to perform all the steps of a process according to one of claims 15 to 30, when the computer program is run on a computer or a corresponding computing unit. Computer can be integrated in the monolithic electrooptical module or can be connected to it through datalines or wireless interfaces.

All in all, the invention, at least in the described embodiments provides for customers and users, e.g. in the field of lateral flow immunoassays, several features besides accurate performance: handheld or mobile device, convenient operation and operational robustness, display of positive, negative or invalid test results (for yes/no answers), display of exact quantitative or invalid test results (for quantitative tests), connectivity to USB port, internal memory for a large number of recordings, possibility of adding a printer to the device, possibility of adding calibration data for different batches without a computer, low price, appealing industrial design, to a lesser extend audio visual displays for positive, negative or invalid test results, high throughput function, automated start or repeat of strip recording, kinetic recording of test bands, and wireless transfer.

The invention provides among others for mobile, pocket sized systems applicable to both, lateral flow and tube formats, for point of test/point of care tests based on fluorescence read-out. These tests work from the sample directly without the need of time consuming sample storage, sample transportation and sample preparation. Examples will be shown for protein as well as nucleic acid based tests and small molecules such as drugs. The core consists of a battery operated, 90 g electrooptical unit with optional wireless data transfer, which has been optimized to achieve highest accuracy and sensitivity paired with simplicity of use.

The robust systems have been shown to detect as low as 17 nucleic acid molecules (MRSA III) with subtyping specificity in 11 minutes in combination with Molecular Diagnostics techniques. The mobile devices demonstrated precise results from whole blood and Urine to the fully documented data within the low minute range for infectious diseases and drug testing using lateral flow test strips. The affordable devices are ideally suited to serve both, point of care and home care markets due to their specificity, speed and simplicity of use as well as specialty applications such as manned space flight due to their low weight and size.

Further features and embodiments of the invention will become apparent from the description and the accompanying drawings.

It will be understood that the features mentioned above and those described hereinafter can be used not only in the combination specified but also in other combinations or on their own, without departing from the scope of the present invention.

The invention is diagrammatically illustrated in the drawings by means of an embodiment by way of example and is hereinafter explained in detail with reference to the drawings. It is understood that the description is in no way limiting on the scope of the present invention and is merely an illustration of a preferred embodiment of the invention.

### BRIEF DESCRIPTION OF THE DRAWINGS

In the drawings,

FIG. 1 is unequipped electrooptical module in a schematical view,

FIG. 2 is the electrooptical module shown in FIG. 1 in an equipped state,

FIG. 3 is first embodiment of an optical measuring instrument according to the invention,

FIG. 4 is a second embodiment of an optical measuring instrument according to the invention,

FIG. 5 is a third embodiment of an optical measuring instrument according to the invention,

FIG. 6 is the optical measuring instrument of FIG. 3 partly opened,

FIG. 7 is an embodiment of the monolithic module,

FIG. 8 is another illustration of the monolithic module,

FIG. 9 is a representative scan of a lateral flow strip,

FIG. 10 is a scan showing raw data of a reproducibility study,

FIG. 11 is a schematic representation of a measurement principle,

FIG. 12 is schematic view of different sample holders,

FIG. 13 is view showing the principles of confocal and off axis design,

FIG. 14 is a plot showing the results of a measurement at ambient light,

FIG. 15 is a plot showing the real-time detection of MRSA III,

FIG. 16 is a plot showing the endpoint detection of MRSA III,

FIG. 17 is a measuring set up,

FIG. 18 is another measuring set up,

FIG. 19 is a plot of raw data of a label-free measurement.

### DETAILED DESCRIPTION

The figures are described cohesively and in overlapping fashion, the same reference numerals denoting identical parts.

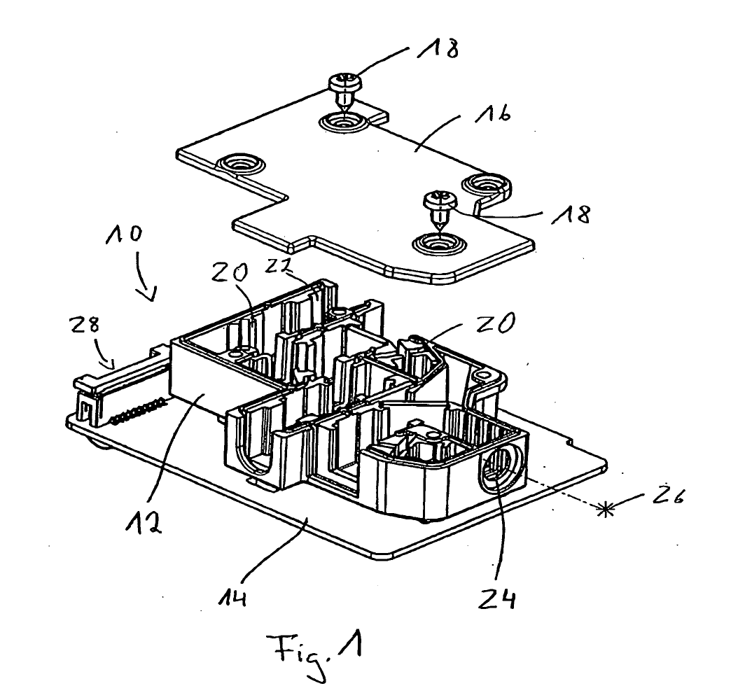

FIG. 1 shows an monolithic electrooptical module 10 used as the main component of an optical measuring instrument and an optical measuring device according to the invention in an unequipped state.

The monolithic module comprises a mechanical bench 12 formed in one piece for carrying all necessary optical and electronic elements, e.g. the source for an electromagnetic beam and a sensor for detecting an output of any interaction between the emitted electromagnetic beam and a specimen to be investigated.

The mechanical bench 12 is disposed on a printed circuit board (PCB) 14 carrying electronic elements and conductive traces. Furthermore, a cover 16 is provided for covering the mechanical bench 12 and protecting the components (not shown in this view) within the mechanical bench 12. The cover 16 can be fixed by means of screws 18 to the optical bench 12.

Inside the mechanical bench 12 a number of slots 20 and supports 22 are provided for receiving the electrical and optical components. It should be noted that the mechanical bench 12 according to the invention allows for secure and predetermined positioning of multiple optical, electrical, and electronical components which in turn can be electrically connected by traces of the PCB 14.

An aperture 24 is provided in the front part of the mechanical bench 12 to allow the generated electromagnetic beam and the output signals to pass through.

A sample position 26 in front of the module 10 defines the position of a sample of any kind. During the measurement the sample position 26 can be moved relatively to the module 10 and/or the module 10 can be moved relatively to the sample position 26.

In place of the sample position 26 there can be a mirror, prism or any other optical element deviating or extending the path of the electromagnetic beams coming from and going to the module 10.

In the rear part of the module 10 an electronic interface 28 is provided for transmitting obtained results to a computing and/or displaying unit. The shown interface 28 can be a wire based or a wireless interface.

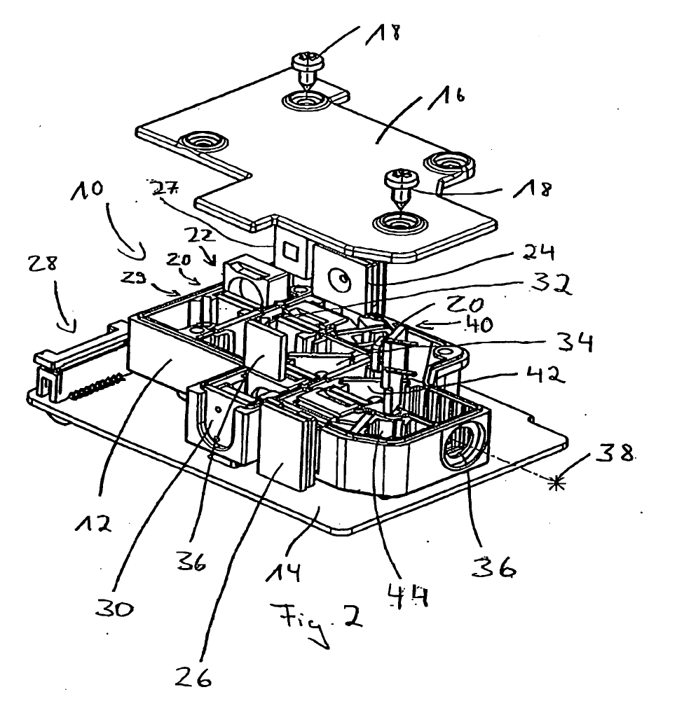

FIG. 2 shows the module 10 of FIG. 1 in an equipped state e.g. comprising two sources 24 and 26 and two sensors 27 and 30. The drawing shows a number of electronic and optical components received in the mechanical bench 12, e.g. in the slots 20 and supports 22.

The first source 24 generates the electromagnetic beam which passes through the mechanical bench 12 along a predetermined path preset by a first beam splitter 32 and a second beam splitter 34 to the aperture 36 for irradiating the sample at the sample position 38. Furthermore, a first monitor diode 40 is provided to monitor the first source 24.

The second source 26 generates the electromagnetic beam which passes through the mechanical bench 12 along a predetermined path preset by a third dichroic beam splitter 42 to the aperture 36 for irradiating the sample at the sample position 38. Furthermore, a second monitor diode 44 is provided to monitor the second source 26.

The output signals of the interaction between the electromagnetic beam and the specimen to be investigated in the sample pass the aperture 24 to be directed to the first sensor 27 and to the second sensor 30, respectively. The sensors 27 and 30 detect the output signals which are processed by the electronic components within the mechanical bench 12 to generate the expected results which can be transmitted via the electronic interface 28 on board. The beam passes again dichroic beam splitters 32, 34, 42, respectively, and mirror 29.

All of the electronics to perform the monitoring, the measurement and the processing of the detected data is integrated within the shown module 10.

Therefore, the shown module 10 together with the optical and electronic components within the mechanical bench 12 form the optical measuring device according to the invention. The module 10 along with the necessary components form a compact selfconsistent unit for all the functions needed to perform the measurement including the signal processing for conducting the measurement and for obtaining the results.

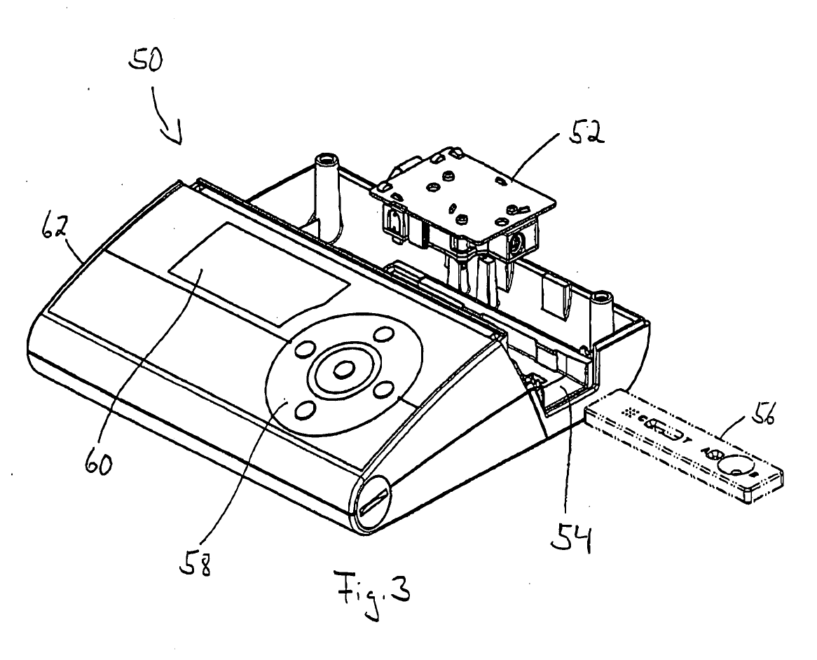

FIG. 3 shows a first embodiment of an optical measuring instrument 50 according to the invention.

This measuring instrument 50 comprises a monolithic electrooptical module 52 comprising the optical and electronic parts for performing a measurement. This module 52 corresponds to the module 10 in FIGS. 1 and 2.

Furthermore, the instrument 50 comprises a sample holder 54 for receiving a sample 56 which is in this case a laminar flow device.

The sample 56 can be inserted into the sample holder 54 and can be moved relatively to the module 52. Additionally, the module 52 can be moved relatively to the sample 56.

Moreover, the instrument 50 is provided with a key pad 58 for controlling the measurement and a display 60 for showing the obtained results of the measurement.

Generally, the instrument comprises a main body 62 and the sample holder 54 connected to each other. The main body 62 includes the key pad 58 and the display 60 and remains basically the same for all types of sample holders 54. The sample holder 54 receives the sample 56 which is in this example a laminar flow device. Also embedded in the sample holder 54 is the monolithic electrooptical module 52. The module 52 can be moved relative to the sample 56 (means for movement not shown).

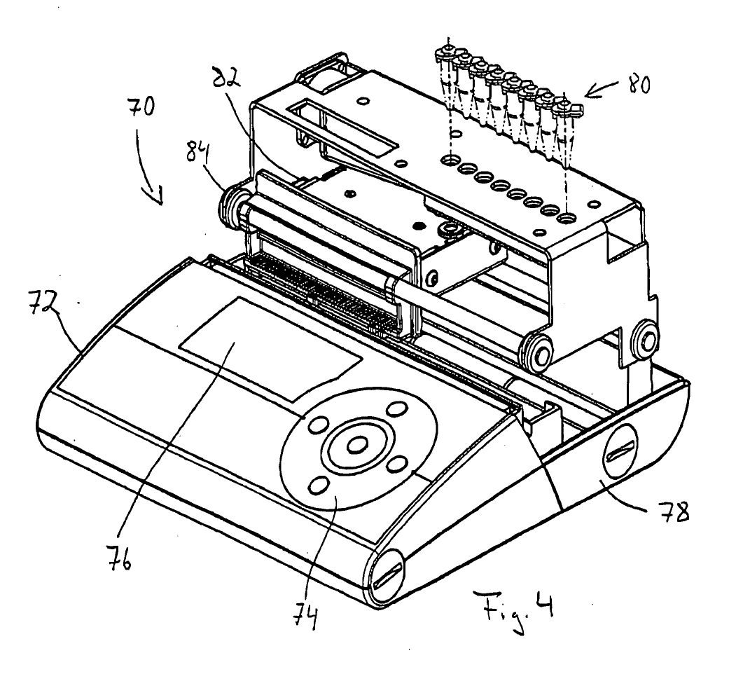

FIG. 4 shows a second embodiment of the optical measuring instrument 70 according to the invention. This instrument 70 comprises a main body 72 provided with a key pad 74 and a display 76 as the instrument 50 shown in FIG. 3.

The main body 72 in this example is connected to a sample holder 78 for up to eight vials/PCR tubes 80. A monolithic module 82 can be moved by means of a scan mechanics 84 in x-direction relatively to the PCR tubes 80. The module 82 corresponds to the module 52 in FIG. 3 and module 10 in FIGS. 1 and 2.

FIG. 5 shows a handheld measuring instrument 100 according to the invention. This instrument 100 comprises a main body 102 having a key pad 104 and a display 106. The main body 102 carrying a monolithic electrooptical module 108 can be connected by means of an interface 110 with a sample holder 112 for a laminar flow measurement. The sample holder containing a laminar flow device can be moved in x-direction relatively to the monolithic module 108.

The shown measuring instruments can among others be used for colorimetric lateral flow immunoassays as well as luminescence, e.g. fluorescence, measurements or nucleic acid assays.

Transfer of the results e.g. via USB provides a complete PC functionality for further documentation, printing and data storage. Wireless communication is an option.

The electromagnetic realisation of the device can be customised for wave lengths in the UV and visible region. Especially for applications in fluorescence mode, which is one of the preferred operating modes the device can be customised for specific fluorescence dyes with excitation spectrum in the UV and visible range of 365 nm to 720 nm and cassette formats. Today available light sources filters and available dyes allow for customizing in the range of 365 to 720 nm. This covers all applications of lateral flow markets.

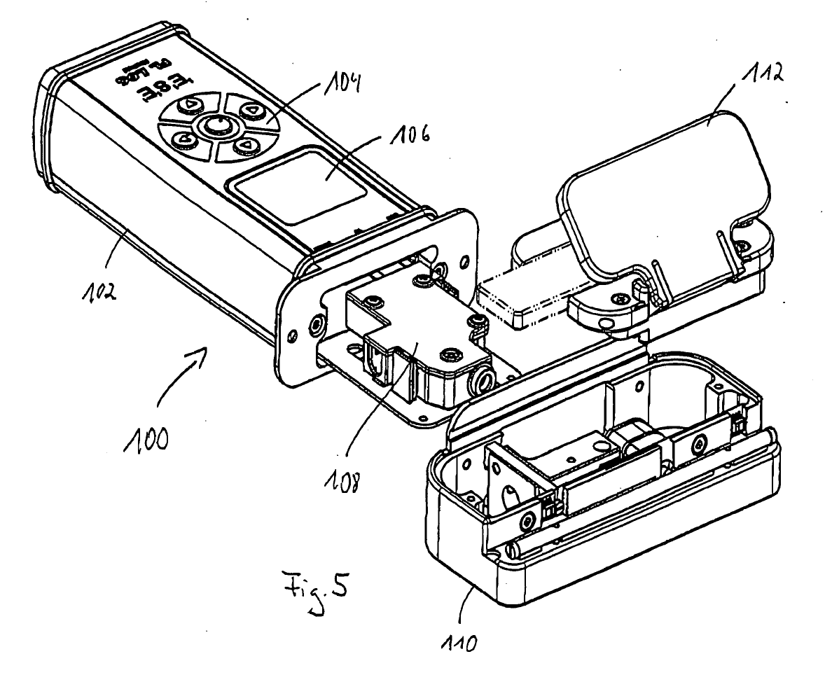

FIG. 6 shows the measuring instrument 50 of FIG. 3 in an partly opened manner. The view illustrates the connectibility between the main body 62 and the sample holder 54. Therefore, the main body 62 can be combined with various sample holders 54 of different kind depending on the kind of measurement to be performed.

The ability to easily replace the sample holder 54 provides for an measuring instrument 50 which can be used in manifold measuring principles together with multiple sample formats.

Therefore, the sample holder 54 is provided with a connector 90 interacting with an corresponding member on the main body 62 for connecting the sample holder 54 to the main body 62 to configurate the instrument 50. Accordingly, the main body 62 corresponding to main body 72 in FIG. 4 can be connected to various sample holders 54 depending on the measurement to be performed and the used sample format.

The sample holder 54 is designed to receive assemblies to adopt various sample formats.

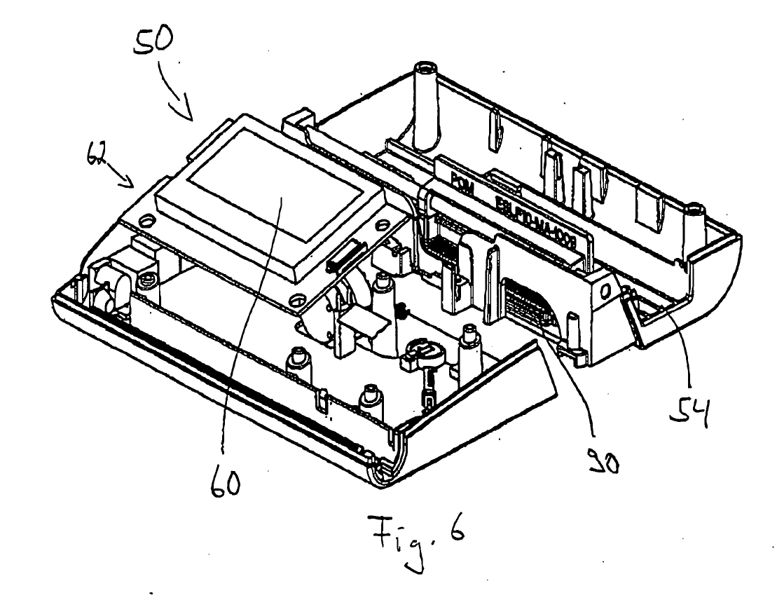

FIG. 7 shows a possible embodiment of the mechanical bench according to the invention, generally designated 400.

It will be seen that all the components are integrated in a housing 402. A first source 404 and a second source 406 are provided, the first source 404 being associated with a first monitor diode 400 and the second source 406 being associated with a second monitor diode 410.

Between the first source 404 and first monitor diode 408 an optical module is provided, namely a first filter 412. Similarly, a second filter 414 is arranged between the second source 406 and the second monitor diode 410.

Also shown are a first sensor 416 and a second sensor 418, which detect beams reflected through associated beam splitter 422 and mirror 420, respectively. The first filter 412 and the second filter 414 correspond in their optical properties to a first beam splitter 424 and a second beam splitter 426, so that the monitor diodes 400 and 410 are exposed to beams of wavelengths matching to the wavelengths the sensors 416 and 418 are exposed to.

Arrows 430 indicate the optical paths of the beams produced by the sources, while light traps 432 substantially reduce the amount of stray light, thus making it possible to obtain very specific signals.

Thanks to the specially developed housing shape with integrated light traps 432, the light which is being collected from the sample at sample position 433 and through the aperture 431 is being reflected multiply at optical elements like beam splitter 422, 424 and 426 defining the wave lengths of the light used for detecting the signals from the sample by the sensors 416 and 418, while light of non-specific wavelength and stray light is reduced to insignificant levels of intensity due to the light traps 432. Thus, the light fraction which is not specific for the sample is guided into the light traps 432, as indicated by arrows 434.

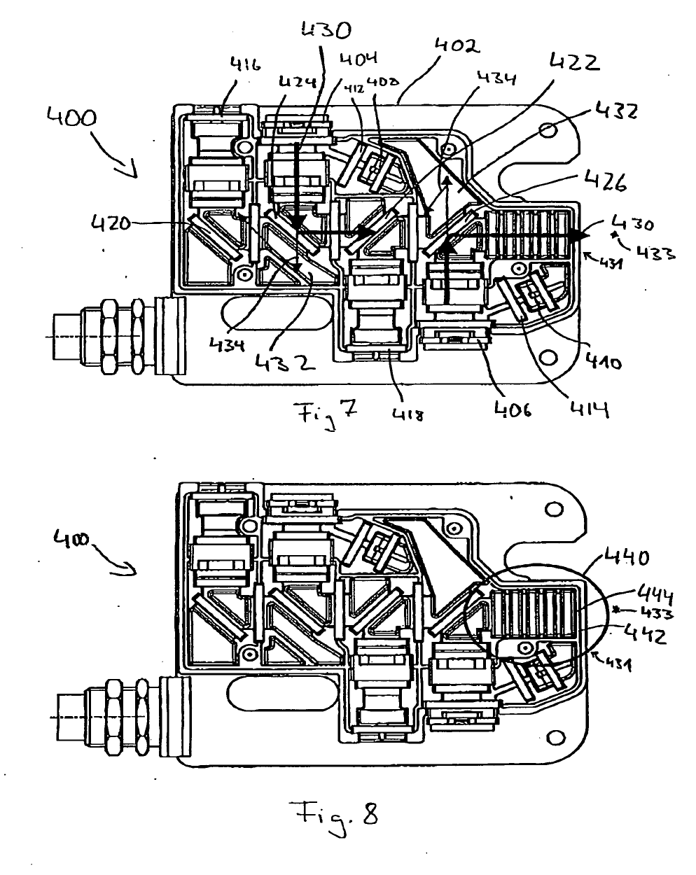

In FIG. 8 the region of the exit opening is shown inside a border 440. In this region additional light traps 442 are incorporated in the form of ribs. These reduce the stray light which enters the system from outside through the aperture 431. In addition, further filters which block unwanted spectral ranges may be inserted between the ribs or in the recesses formed by the ribs.

### Colorimetric Measurements

The shown instruments and devices can be used for colorimetric lateral flow immunoassays or any luminescence, e.g. fluorescence, measurements of e.g. nucleic acis assays.

The principle of colorimetric scanning of the lateral flow strips is performed by moving the lateral flow strip over a light source or vice versa. The instrument is adjusted so that the light reflected from the strip membrane comes back into the detector and produces a high signal representing the baseline. When the control band passes the light beam, the intensity of reflected light is decreased because the gold beads occupying the band absorb light at that wavelength. This is visible as a negative signal.

Gold particles used in lateral flow techniques are typically 40 nm in size and have an absorption maximum at 540 nm. Once the control band has passed the light beam, the light intensity reflected by the strip material is back at the baseline level. The same description applies for the test band. The intensity of the reflected light is negatively proportional to the absorption of the light in the test band. Absorption, in term, is depending on the concentration of the absorbing specimen within the sample contained in the band. Therefore, accurate quantification of colorimetric lateral flow tests can be achieved in a very convenient way.

It should be pointed out that the measurements described above are not convential absorption measurements as light source and detector are arranged in a confocal (0 degree angle) not a 180 degree geometry. The measurements may be best described as reflectance or contrast measurements.

The diameter of the light spot projected onto the surface of the strip is about 1 mm distance of the light source to the strip surface about 6 mm to 9 mm, which allows for a good numerical aperture. A simple LED as light source as well as the miniaturized optoelectronic core provides a cost efficient device. Data acquisition rate is 1500 data points per second and per scan: one scan takes only one second. The device can automatically find the peaks of the control band and the test band(s) and stores these data in the internal memory. This way, up to 2000 scans can be stored without the need of an external computer.

The device for example can be connected via USB port to any computer. Data storage of the measurement curves, peak intensities, position of the peaks, ratios of the peaks and any further data analysis can then be performed if desired. Wireless data transfer e.g. via BlueTooth is an optional add on.

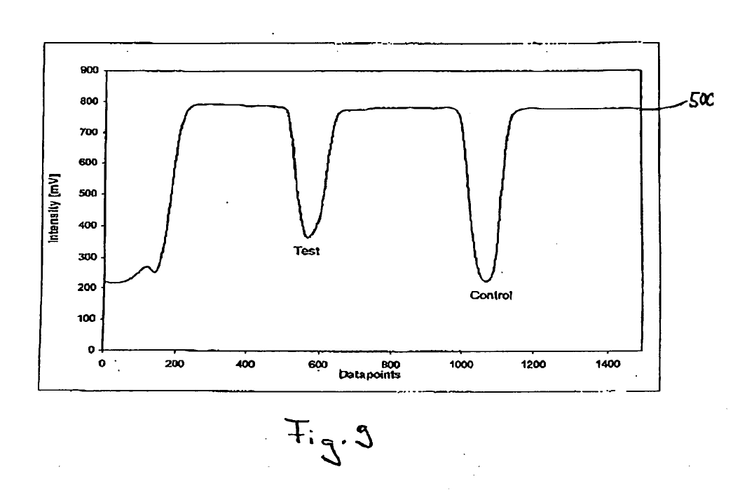

FIG. 9 shows a representative scan of a colorimetric lateral flow strip using 40 nm Gold beads as labels. 50 μl urine sample spiked with 40 ng/ml THC2 were applied to the sample filling port of the strip in the cassette. THC is a cannabinoid and is used for testing of drug consumption in blood and urine. Such lateral flow tests are available. The scan was recorded after the sample was applied for 9 min. 1500 data points were recorded. The scan was 1 second. Control and test band are clearly visible and dependent on the concentration of analyte. Reference numeral denotes the baseline.

The unique optical measuring device provides a highly sensitive lateral flow strip reader in a mobile and handheld format. This technology is essential to make the new generation of immunoassays usable in many new applications. With the latest micro optics technology and highly integrated electronics, the sensitivity of the device is comparable to expensive benchtop instruments. To operate the device is as simple as to insert the strip and to press one button. Subsequently the device controls the automated scan, calculates the results and documents the measurement completely. Up to 2000 scans can be stored.

Another reproducibility study was performed by scanning a cassette by removing the cassette in between each scan and placing it again into the device prior to the next scan. FIG. 10 shows the results of this experiment.

In this experiment a urine sample spiked with 25 ng/ml THC2 was applied to the lateral flow immunoassay and was scanned ten times using the so called GoldScan handheld device. The cassette was removed after each scan an newly placed into the instrument prior to the next scan.

### Fluorescence Measurements

The devices shown throughout the figures can also be used for luminescence, especially fluorescence read out. Fluorescence labels are used today in almost any industry and research area. By replacing the gold beads in lateral flow assays by fluorescence labels a more sensitive read out can be achieved. Sensitivity was increased by 100-1000 fold. This catapults lateral flow immunoassays into a sensitivity range of ppt (parts per trillion) and adds a new dimension to lateral flow assays as they can now be applied to new areas and markets. Luminescence can be read principally in a variety of ways, which encompasses for example intensity measurements of fluorescence, time resolved luminescence, phase modulation, luminescence after two photon excitation and fluorescence anisotropy or polarization. Of those, simple intensity measurements are the cheapest and easiest to perform and are most applicable to lateral flow strips.

The assignee has developed handheld devices for Lateral Flow Immunoassays both for Gold Beads based colorimetric read out (GoldScan—see example above) as well as Fluorescence read out (FluoScan) to assist the operator with high performance and convenience. The device also has been used for reflectrometry (absorbance, reflectrometric interference spectroscopy).

The FluoScan device is identical in design and performance to the GoldScan described above and has the same features. The light emitted from the sources is being projected onto the surface of the lateral flow strip. The instrument is adjusted such that the auto fluorescence and the stray light of the strip result in a very low signal due to the confocal design. Once the strip moves over the light beam or the device moves over the strip and once the light beam reaches the control band, a high fluorescence signal is recorded since the fluorescence labels occupy the area of the control band. Behind the control band the fluorescence intensity is at background level until the beam reaches the test bands and the sample signal rises according to the amount of fluorescence labels contained in the sample band. One scan takes only one second and records 1500 data points.

Behind the control band the fluorescence intensity is at background level until the beam reaches the test bands and the sample signal rises according to the amount of fluorescence labels contained in the sample band. One scan takes only one second and records 1500 data points.

The instrument for example provides up to two different excitation sources and can detect at two different emission wavelengths. Scanning of multiplexed assays is therefore simple as multiple test bands and multiple dyes can be recorded on the same strip. Screening of panels of analytes or pathogens is no longer a limitation but now becomes possible by this measuring device.

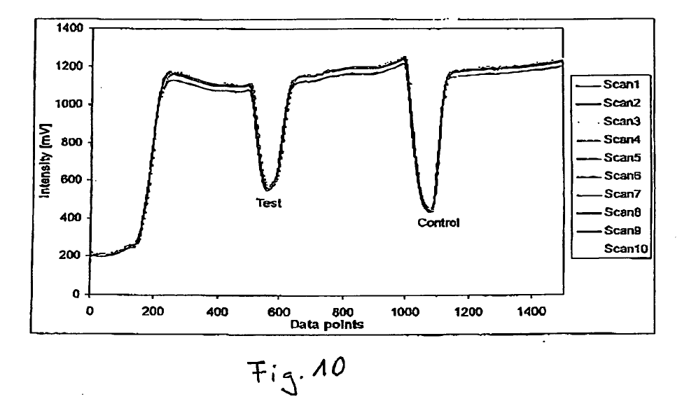

A schematic representation of the measurement principle is shown in FIG. 11 representing the workflow and the obtaining of peak data.

A sample 550 is applied to a strip 552 binding the analyte. Arrow 554 illustrates the direction of sample flow and scanning. At points 556 and 558 the control and test bands become visible. The scanning 560 of the strip results in peaks of control and test bands. With help of this qualitative measurement the results can be electronically reproduced.

The FluoScan handheld lateral flow device is also appropriate to scan fluorescence latex beads. In an experiment performed MDMA (Ecstasy) was spiked into urine samples at different concentrations (0, 125, 150, 250, 500, 750 and 1000 ng/ml MDMA) to obtain a standard curve for quantification purposes. Four test strips for each concentration were used to average variations. 15 μl of spiked sample was applied to the test strip and the strips scanned after 15 minutes using the FluoScan handheld device.

Quantification of results can be performed by using a standard curve as described above, but an internal standard can also be used. The ratio of intensities of control and test bands represent the quanitative result. The data can be normalized at the peak intensity of the control band. Once the performance of the test has been characterized in terms of intensity of control band vs. intensity of test band for different concentrations this parameter can be used for quantification as this ratio is constant for a given analyte concentration. No additional evaluation needs to be done. This is demonstrated in the following experiment: Different analyte concentrations were applied to a lateral flow strip and the strips scanned. Ratios of the intensities of control and test bands were calculated.

When connected to a computer, the FluoScan device can be operated through a user friendly and self-explanatory software interface. The graphic user interface is connected to the USB port by pressing the Connect Button, the scan is started by the Start button, and the wavelengths are selected in a pull down menu called Type. The user has also the option to perform repeated scans by entering a number of repeats into the field Cycles. The other parameters have default values by the manufacturer and apply to different cassette formats. Peak intensities and positions are automatically found by the instrument. It is emphasized here that for routine applications a quantitative value or an action based data output is much more desirable as the user does not want to be involved in the burden of interpreting data.

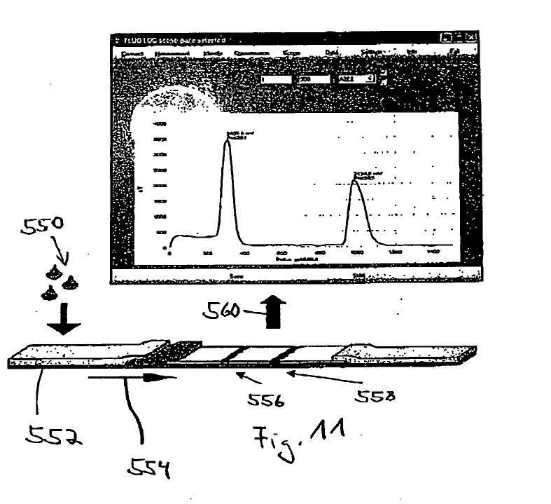

FIG. 12 shows different embodiment of sample holders which can be used in connection with the disclosed devices and instruments.

The drawing illustrates a special cuvette holder 600 for industrial applications. Another cuvette holder 602 and a special cuvette holder 604 for environmental analysis also can be used.

Arrows 606, 608 and 610 show the direction for insertion of the monolithic module.

### Confocal Geometry

In order to allow for increased positioning tolerance of the sensors and to be able to adjust the sensors to different focal lengths, the device is designed according to confocal principles rather than an off-axis geometry. Non-stationary devices, such as used for surface measurements in field based tests need to handle higher positioning tolerances. In liquids, the sensors have been shown to detect 0.5 pM solutions of Fluoresceine in a standard cuvette and demonstrate therefore highest sensitivity. Currently efforts are under way to improve sensitivity even further by a factor of 100 to 1000. The confocal optics of the device makes it unsensitive to mechanical unevenness of a sample and secures highest signal and lowest background intrinsic features of confocal design.

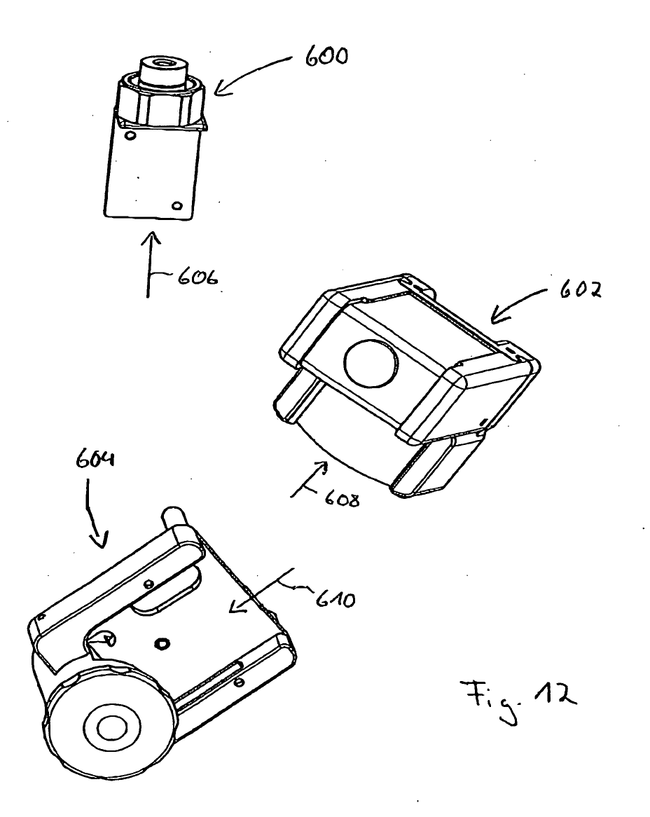

FIG. 13 shows the principles of confocal 650 and off axis 652 design. The confocal design 650 comprises a LED 654 as the source and a photo diode as the sensor. Accordingly, the off axis design 652 comprises a LED 658 and a photo diode 660. The sample position in the confocal design 650 is denoted with 662 and in the off axis design 652 with 664.

Among other factors, the confocal geometry allows for higher tolerances in positioning accuracy which is an important point to consider for a non-stationary sensor. If the position 662 is moved vertically, the off axis design 652 is out of focus and will not yield a signal.

Despite the sensitivity in terms of concentration of analyte, the electronics components must handle currents in the femto Ampere range. The standard optoelectronic unit can measure down to orders of 10 femto Amperes as demonstrated in an experiment described in FIG. 3. The units are therefore ideally suited to serve other analytical techniques as well such as electrochemical measurements with highest sensitivity and accuracy. Also dependence of data output on ambient temperature of the sensors is low.

### Handheld and Mobile Testing Platforms

The shown devices and instruments address the need for handheld and mobile testing platforms. There are currently 1415 infectious diseases known to modern medicine. Additionally there is a need for diagnostic testing for drug consumption, toxin determination in food and agricultural products, detection of genetically modified organisms, cancer markers, biothreat agents, allergological and immune response parameters, human identification and many others more. Many of these tests are performed by non-specialists, in the field or on the bench top in a laboratory. The demand for small devices is driven by simple factors such as scarce space resources. Far beyond that, mobile and handheld devices allow to probe for targets in the field. Demand ranges from biothreat agents and homeland security to epidemiological monitoring, bed site testing, telemedicine, to the home care market. Drivers for the use of such systems are costs, convenience, rapid turnaround time, decreased risks, privacy, education level, epidemiological resolution, lack of power availability, and space limitations. Often, the devices are operated by non-experts, whereas laboratory personnel is usually trained to operate sophisticated equipment. An outbreak of a contagious disease within a military camp for example can be avoided if a high resolution of monitoring the epidemic can be provided through on-site testing devices. Bed site testing allows for results in the emergency room, ambulance or hospital and renders sending the sample to the reference laboratory obsolete. Turnaround time and operational cost savings can be increased significantly if sample storage and transportation can be avoided. Commercial examples are pregnancy tests and glucose monitoring devices.

Devices serving these markets need to provide accurate results, be robust, affordable, easy to operate and provide rapid turnaround time among others (Table 1).

TABLE 1
Some drivers, rationale and concluding features
for handheld/mobile test platforms

| | | Resulting test |
|---|---|---|
| Driver | Rational | platform features |
| Cost | Reducing the | Affordability |
| | number of steps of | |
| | the workflow saves | |
| | time and money | |
| Rapid turnaround | On-site testing | Mobility, provides |
| time | avoids sample | rapid test procedure, |
| | storage and | preferably avoids |
| | transportation | sample preparation, |
| | | automated documentation |
| | | of results |
| Convenience | Mobility brings | Mobility, small |
| | the test to the | size, low weight, |
| | sample | physical robustness, |
| | | operational robustness |
| Decreased risk of | less steps in | Mobility |
| sample | workflow | |
| contamination | | |
| Decreased risk of | less steps in | Mobility |
| Infection of | workflow | |
| personnel | | |
| Decreased risk of | no sample storage | Mobility |
| Degradation of | required | |
| sample | | |
| Decreased risk of | less probability | Mobility, |
| false positive and | of contamination | Sensitivity and |
| false negative | due to less steps | Specificity |
| results | involved | |
| Educational level | Operators are | Operational robustness |
| | often laymen and | (simple one button |
| | non-experts | operation), automated |
| | | data interpretation, |
| | | storage and documentation, |
| | | wireless data transfer |
| Epidemiological | monitoring of | Mobility, |
| resolution and | epidemics | automated wireless |
| monitoring, | | data transfer, |
| biothreat | | Affordability, |
| surveillance | | small size, rapid |
| | | testing, Sensitivity, |
| | | Specificity |
| Lack of power | no power plug in | Battery Operation |
| availability | the field | |
| Privacy | pregnancy is a | Mobility |
| | personal matter | |
| Space limitations | space is a scarce | Mobility, small |
| | resource | size |

The current techniques display limits in combining important parameters. The parameters listed in Table 1 serve as barriers to entry for most technologies and often limit exploitation of existing techniques. For example, Nucleic Acid Amplification is needed to accurately detect viral, bacterial and fungal species on a subtyping specificity level. This is needed to distinguish for example the dangerous H₅N₁ birdflu subtype from other less dangerous influenza virus subtypes.

The first step should however be an accurate diagnosis, among others to avoid unnecessary prescriptions of antibiotics. The overwhelming use of antibiotics has led to the appearance of mutant pathogenic strains, withstanding those therapies. Prominent examples are the Methicillin Resistant Staphylococcus Aureus (MRSA) strains. Although the Polymerase Chain Reaction (PCR), a nucleic acid amplification method is extremely sensitive and specific it is not ideal to be performed in a handheld or mobile format, particularly when rapid turnaround time is desired. Extensive heating and cooling steps require sophisticated and heavy instrumentation such as a thermal cycler, a lot of power and at least one hour time, not including time consuming and troublesome sample preparation procedures. Additionally, temperature homogeneity is very critical to achieve accurate results and a high degree of sample purity is required.

The need for extensive and time consuming sample preparation steps is one of the most limiting factors for diagnostics tests to be applied in a home care and point of care setting. The entire workflow needs to be considered not only the actual assay (Table 2). Turnaround time is critical and includes steps such as sample storage and transportation, which can take days to weeks in some cases. Extended and inaccurate sample storage and transportation may lead to degradation and contamination of samples, resulting in elevated false positive and false negative rates as well as increased risk of infection of the personnel handling the samples due to the number of handling steps of the sample. It also places a burden on the cost of the health care system.

TABLE 2
Steps and Time involved in sample testing

| Step | Time |
|---|---|
| Sample Collection and Documentation | Minutes to Days |
| Sample Storage | Hours to Weeks |
| Sample Transportation | Hours to Days |
| Enrichment of Targets (for some | Hours to Weeks |
| applications) | |
| Sample Preparation and Concentration | Hours |
| Assay Test | Minutes to Hours |
| Data Acquisition | Seconds to Minutes |
| Data Storage and Retrieval | Seconds and less |
| Data Interpretation | Seconds to Minutes |
| Data Communication and Transfer | Seconds to Hours |
| (to patients, epidemiological centers, | |
| regulatory institutions, etc.) | |

Concluding from the list in Table 2, mobile systems must meet all of the above. Mobile tests avoid sample storage and transportation altogether. Mobility alone still does not address the sample preparation part. While many groups have tried to miniaturize the sample preparation steps of current procedures, the assignee has taken another approach: This is to combine its mobile and handheld devices with those assays, which naturally avoid the most time consuming steps, such as extensive sample preparation. This allows for on-site testing and rapid time to result combined with decreased risk for personnel and false positive or false negative rates. Mobile Systems must ideally work from the sample directly and be simple to operate. There are only a handful of test procedures, which may fulfil this paradigm. Lateral flow assays for example have been shown to work from blood, urine or saliva directly.

The systems according to the invention meet all of the other criteria for field based tests as described in Tables 1 and 2.

### Nucleic Acid and Amplification Assay

Another method discussed here is a novel nucleic acid amplification technique called Recombinase Polymerase Amplification (RPA).

RPA is an isothermal nucleic acid amplification technique. The nature of inhibitors in samples and approaches to reduce their effects may be re-thought when novel nucleic amplification methods are assessed. For example, rather than purify the nucleic acid to remove potential inhibitors they may be diluted down instead. This requires a method that can be upscaled in terms of volume. PCR is difficult to be performed in high volumes as the heating and cooling steps are not compatible with the time-to-result requirements. Additionally, working from clinical samples at high temperatures may lead to coagulation of proteins and outgassing of the samples. In such methods, extensive sample preparation procedures are a must. Every step however has an efficiency less than 100% resulting in loss of targets.

This is of particular interest when dealing with low copy numbers. If a method is upscalable however, inhibitors can be diluted, no concentration procedure has to be applied and the entire volume can be used without loss of a single target molecule. Enrichment steps such as growth of cell cultures may be significantly shortened. Less steps also mean decreased risk of sample contamination. Higher sample volumes are also desirable to address the target delivery problem: This is to deliver a statistically relevant and representative amount of target molecules to the test. Blood tests for example often require a sample volume of 0.5 ml to be drawn to avoid missing out on extremely low concentrated targets and to conclude with meaningful results. Regulatory requirements for food tests require even 25 g of sample to circumvent the target delivery problem. Currently time consuming concentration or enrichment procedures are applied.

Upscalable isothermal nucleic acid amplification tools therefore hold the strongest promise in overcoming today's bottlenecks on simple, rapid, sensitive and specific diagnostics tests. Such tests are desired particularly in the field, in a point of care or home care setting, where bulky and sophisticated instrumentation is not available or cannot be operated and at all places where cost is an issue. However, most isothermal methods lack scalability, sensitivity, rapid time to result, specificity or a combination of those parameters.

Furthermore, molecular diagnostics techniques have gained substantial market share for routine diagnostics tests. The appearance of Antibiotics Resistant Strains of pathogens for example has increased to an alarming level and increased demand for such tests. In reference laboratories, DNA/RNA based tests are among the fastest growing products and services. This is due to the extreme sensitivity and specificity, which can allow for subtyping of species. Such high specificity can only be matched by time consuming microbiological procedures and can range from days to weeks. Current Molecular diagnostics tests display rapid access to the results in the 1 hour range. Most recent advancements have demonstrated however, that time-to-result of molecular diagnostics tests can be reduced to about 30 min while maintaining high sensitivity and specificity (Recombinase Polymerase Amplification, RPA) and are demonstrated here to work in whole blood. RPA is applicable to clinical samples (whole blood) without prior sample preparation steps. MRSA DNA was spiked into the blood in different concentrations (1000, 100, 10 and 0 copies) and then subjected to RPA at 37° C. Volume in this experiment was 100 μl and the blood was diluted by a factor of 30% when adding the reagents directly into the blood. This feature of RPA is ideal for field based tests: Field based test based on RPA can provide a rapid turnaround time as they will avoid sample storage, sample transportation and extensive sample preparation. The measuring instrument according to the invention is enabling for the performance of RPA under the mentioned conditions fullfilling all the demands of the described applications.

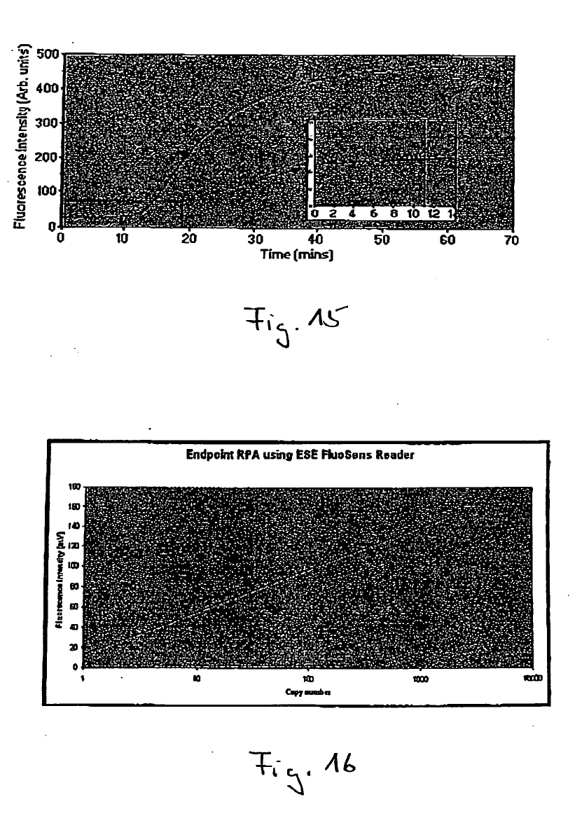

Due to the low noise and high sensitivity of the handheld fluorescence readers we could demonstrate the detection of 2000 isolated DNA copies of Methicillin Resistant Staphylococcus Aureus in only 11 Minutes (FIG. 15, real-time) and detection down to 17 copies (FIG. 16, endpoint). Interestingly, at these copy numbers, the end point assay provides a quantifiable result.

FIG. 15 shows a real-time detection of MRSA III to determine Antibiotic Resistance using Recombinase Polymerase Amplification and the mobile FluoSens device. 2000 copies MRSA III detected within 11 minutes using the FluoSens sensor.

The assays described above have been proposed in reaction tubes (PCR vials) and the read out has been taken directly from the tubes. The handheld TubeScan prototype device provides a kinetic read out of tubes while measuring the fluorescence increase of the reaction over time induced by a FRET mechanism. The tubes are moved over a light source and are illuminated from the bottom. Due to the confocal geometry of the device the fluorescence values are recorded through the same optics as excitation occurred. Scans can be done every five seconds for several hours. In the handheld TubeScan the data of the peak values are saved in the internal memory. Data are displayed in the internal display currently as numbers. A graphic user interface can be added if desired. Although this is a battery operated stand alone device, it can be connected to a computer via USB port for development purposes of assays and to illustrate the data.

FIG. 16 shows the endpoint detection of MRSA III. Endpoint Assay: 0, 17, 170 and 1700 copies of isolated MRSA III DNA were amplified for 60 min using Recombinase Polymerase Amplification (RPA) and detected using mobile FluoSens System. Interestingly, in this range of copy numbers, the endpoint read-out provides a quantifiable result.

### Ambient Light Compensation

LEDs are used as light sources and photodiodes as detectors. A closed-loop feedback is implemented into the sensors to provide a constant light output independent of the LED's temperature. The lengths of the electronic circuits are kept extremely small. The sample is detected once with LED turned on and once with LED turned off to subtract ambient light. This measurement principle allows for fast measurements and low noise with and without ambient light both on surfaces as well as in liquids.

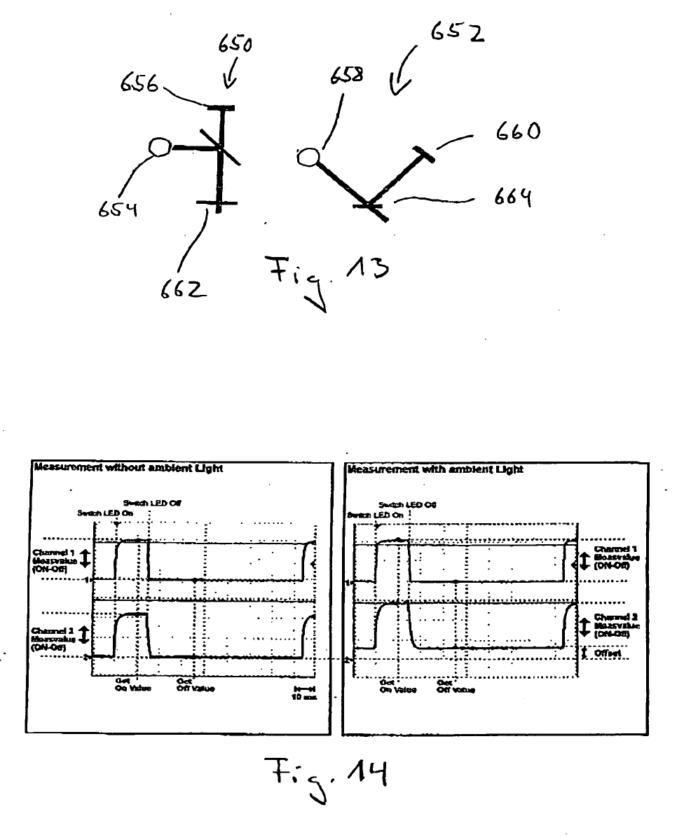

Measurement at ambient light is shown in FIG. 14 wherein an oscilloscope plot of one measurement period of the optoelectronic unit is illustrated. The plot shows truly parallel fluorescence detection in two channels suitable for the measurement of two different dyes and wavelengths. There is no integration of signal as only one value is taken after a certain delay time. On the left side: Measurement in two channels without ambient light. On the right side: Measurement in two channels with ambient light. The off-set of the signal in channel two caused by ambient light is compensated by subtraction of the value recorded once with light source switched on and once switched off. Therefore, the sensors are able to accurately detect signals at ambient light.

Due to the modular design of the assignee's lateral flow reader, the device can be configured for fluorescence read out (FluoScan) and gold bead based calorimetric read out (GoldScan) and be adjusted to different lateral flow cassette formats. The lateral flow cassette carriage can be substituted by a tube rack suitable to scan fluorescence kinetics in multiple tubes such as for real time nucleic acid amplification. The modular design approach allows for cost efficient and rapid customization as well as for exploitation of the device to multiple applications. Both, flexible mobile systems in a suitcase as well as truly handheld and battery operated systems have been built. Wireless data transfer is implemented upon request. The devices are constructed for robustness and are easily operated by a single button. The internal memory and display of the handheld devices provides data output on site and saves up to 2000 scans without the need of a computer. Data output can be qualitative (yes/no/invalid), semi-quantitative (high, medium, low, invalid), quantitative or action based (recommended dose of medication, evacuation of building, etc.).

In contrast to the integrated handheld devices, the mobile systems can come in a suitcase and contain various sensors, an electronics measurement device, cable for connectivity to a laptop or pocket PC, software, lateral flow strips, power adaptor and accessories such as cuvette holder and other. The mobile devices are generally more flexible and the contents of the suitcase can be adapted to a particular application.

### Measuring in Droplets

In many cases it is necessary to measure a specimen in a liquid sample in extremely small sample volumes. Many specimens tend to adsorb to the surface of the sample vessel. This adsorption may cause false analytic results. In very small vessels which intrinsically show a high surface to volume ration this effect may even result in false negative results because all of the specimen may be adsorbed to the surface. A solution to this problem is to measure in wall free sample compartments as provided for example by droplets. In the following fluorescence measurements of test solutions in droplets hanging on the end of a pipette or falling droplets can be used as wall free containers. The results are being compared to measurements in tubes. In all cases the measuring instrument according to the invention has been used.

The experiments conducted show the dependence of fluorescence intensity on acquisition rate, exposure time, pH, volume, distance of measuring device to the sample and concentration recorded using the sensors described. The data may be basis for PCR based and other applications. To achieve exposure times in millisecond range, the droplets were applied to free fall through the excitation beam (at a speed of about 0.3 m/s). The fluorescence measurement can get triggered once a droplet passes the beam. This allows high speed measurements of multiple samples without the need of exact positioning or accurate speed of movement. The data were recorded in a non-optimized system and are considered preliminary. Optimization and customization can result in substantial improvements. The performance was:
15 nM to 500 nM fluoresceine solutions
pH 8.5 and pH 12
5 μl volume

exposure time 4 ms to 20 ms (at 50% peak heights)
acquisition rate 1.5 kHz
distance sample-sensor: 6 mm to 30 mm
room temperature measurements
100 μl PCR tube detected from side through plastic material
study/report describes sensitivity, noise level, speed (acquisition rate) and signal to noise ratio (in terms of signal to standard deviation of noise)

The data in this study show that 5 μl of fluoresceine solutions, pH 8.5 from 15 nM to 500 nM can be detected at 1.5 kHz acquisition rate in standard PCR tubes as well as in droplets with exposure times in the millisecond range, both well above the noise level. The noise level is typically less than 0.5%. The distance of the instrument to the sample was shown from 6 mm to 30 mm. Losses resulting from change in numerical aperture with higher distance were compensated fully by a higher application factor without significant increase of noise when measured in a PCR tube. Volume and pH dependence on the fluorescence signal intensity were surprisingly low. Fluorescence intensities for acquisition rates of one second compared to one millisecond were consistently very similar. This is due to the fact that the used system does not use integration over time when recording fluorescence intensities. The data strongly suggest that the described instruments are very oppropriate to measure specimens in falling liquid droplets.

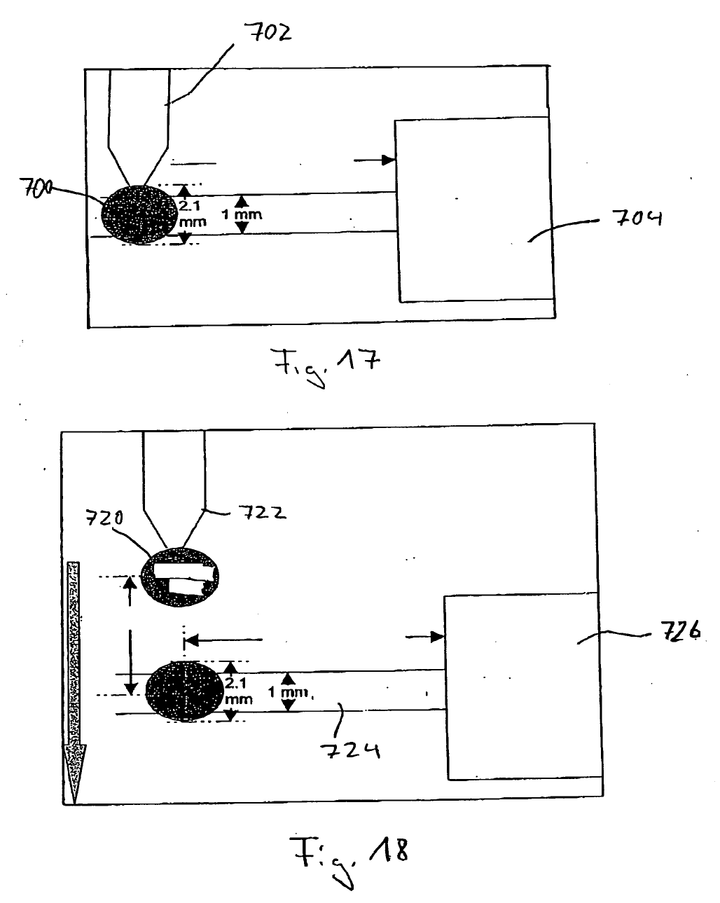

A Fluoresceine dilution series was prepared using Fluoresceine NIST-Standard as stock solution at 50 mM concentration. Final concentrations of solutions ranged from 280 nM to 10 nM. In this first experiment solutions were prepared in 1M NaOH to promote maximum fluorescence intensity of the dye. Excitation wavelength was at 470 nm, emission was detected at 520 nm and above. The volume was illuminated as a droplet hanging on a pipette tip. FIG. 17 shows the experiment set up for performing the measurement. The drawing shows a droplet 700 hanging at a pipette tip 702 during the measurement performed by the device.

The 5 μl Fluoresceine-droplet 700 is positioned at the bottom of the pipette tip 702. The droplet 700 is illuminated using the instrument according to the invention.

Table 3 below shows the concentration of fluoresceine solutions (column 1), the recorded fluorescence intensity in Regular Mode (‘Intensity’, Column 2) with corresponding noise (Column 3) and the 1.5 kHz acquisition rate mode (‘Scope’, column 4) with noise (column 5). For the regular mode ten data points were recorded and averaged (1 second exposure time per data point). In the scope or 1.5 kHz mode 1500 data points were recorded (1.5 data points per millisecond) using exposure time of 1 second.

TABLE 3

| | Intensity | Absolute | Scope | Absolute |
|---|---|---|---|---|
| c | Regular mode | Noise | (1.5 kHz mode) | Noise |
| [nM] | [mV] | [+/− mV] | [mV] | [+/− mV] |
| 280 | 1962 | 4 | 2000 | 6 |
| 240 | 1279 | 3 | 1310 | 4 |
| 200 | 1062 | 4 | 1090 | 4 |
| 160 | 772 | 2 | 792 | 4 |
| 120 | 612 | 2 | 634 | 6 |
| 80 | 395 | 2 | 420 | 4 |
| 40 | 178 | 2 | 200 | 4 |
| 10 | 25 | 1.5 | 45 | 5 |

Parameters for this experiment were:

| | |
|---|---|
| Dye: | Fluoresceine in 1M NaOH |
| Volume: | 5 μl (droplet on pipette tip) |
| Distance sample to sensor: | 6 mm |
| Amplification factor: | 20 * 10⁶ |
| pH: | >pH 12 |
| Ex/Em: | 470/>520 nm |
| Acquisition rate (scope mode): | 1.5 kHz |
| Exposure time: | 1 second |

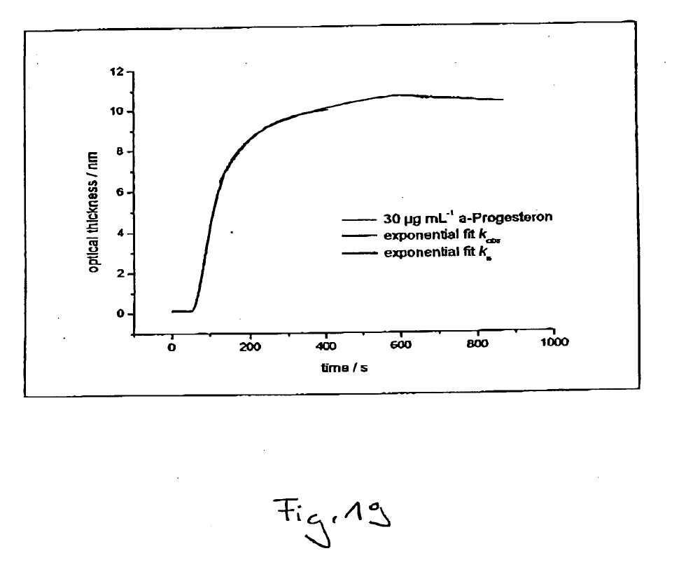

In order to achieve exposure times in the millisecond range without high speed mechanical movement apparatus, the experimental set up as shown in FIG. 18 was used. A droplet 720 was let fall from a pipette tip 722 through a light path 724 of the excitation beam of the device. Different vertical elevation distances of the droplet 720 to the light beam of 5 mm and 10 mm for different concentrations were set up. The horizontal distance of the droplet 720 to a sensor 726 in the light beam was 18 mm. Speed of the droplet 720 is about 0.3 m/s as can be seen from the peak width, assuming a diameter of the droplet of 2.1 mm and width of the beam 724 of about 1 mm.

The fluorescence measurement was triggered once the sensor 726 received a fluorescence signal above a threshold of 60 mV and 30 mV respectively in another experiment. As the data show, the exposure time of the droplet was around 20 ms, this is the total time of the droplet in the light beam recorded as the baseline to baseline values around the peak. The baseline moves up upon entry of the droplet into the beam and comes back down when the droplet leaves the beam. The peak heights at 50% of the maximum show an exposure of only 7.3 ms (11 data points at 1.5 kHz acquisition rate). The 50% values more closely represent maximum illumination of the droplet. Table 4 summarizes the recorded data in this experiment. Noise was measured at the baseline level.

TABLE 4

| | | Vertical | | | | Peak | | Peak | |
|---|---|---|---|---|---|---|---|---|---|
| | | elevation | | | | width | | width | Exp [symbol] |
| | | distance | | | Position | (baseline | Total exposure | at 50% | tim [symbol] |
| | | droplet- | Threshold | | of max | to | Time of | peak | dro [symbol] |
| Conc. of | | light | for fluorescence | | peak intensity | baseline) | entire | height | 50% [symbol] |
| Fluoresceine | | beam for | trigger | Max Peak Intensity | [data | [data | droplet | [data | he [symbol] |
| [nM] | pH | fall [mm] | [mV] | [mV] | point] | points] | [ms] | points] | [ [symbol] |
| 250 | 8.5 | 5 | 60 | 1360 | 18 | 40 | 26.7 | 20 | 1 [symbol] |
| 250 | 8.5 | 5 | 60 | 1979 | 17 | 43 | 28.7 | 18 | 1 [symbol] |
| 250 | 8.5 | 5 | 60 | 1514 | 15 | 38 | 25.3 | 19 | 1 [symbol] |
| 250 | 8.5 | 10 | 60 | 1594 | 11 | 30 | 20.0 | 11 | 7 [symbol] |
| 250 | 8.5 | 10 | 60 | 1461 | 8 | 30 | 20.0 | 13 | 8 [symbol] |
| 250 | 8.5 | 10 | 60 | 1636 | 10 | 31 | 20.7 | 11 | 7 [symbol] |
| 15.63 | 8.5 | 10 | 60 | 80.0 +/− 0.15 | 2 | 20 | 13.3 | 7 | 4 [symbol] |
| 15.63 | 8.5 | 10 | 60 | 93.9 +/− 0.10 | 3 | 23 | 15.3 | 8 | 5 [symbol] |
| 15.63 | 8.5 | 10 | 60 | 95.3 +/− 0.15 | 5 | 26 | 17.3 | 9 | 6 [symbol] |
| 15.63 | 8.5 | 10 | 30 | 82.6 +/− 0.15 | 5 | 22 | 14.7 | 7 | 4 [symbol] |
| 500 | 12 | 10 | 30 | 1791.8 +/− 0.15 | 16 | 38 | 25.3 | 14 | 9 [symbol] |

[symbol]

indicates data missing or illegible when filed

Parameters of experiment and experimental data recorded during fall of droplet 720 through the light beam 724. For some examples, the noise was recorded at the baseline level since there is only one data point at the max peak. Noise has a consistent low value. It is known however from experiments 1, 2, 3 and 4 that the noise using the 1.5 kHz mode is in the 0.6% to 0.1% range. Entries under same conditions represent repeats of experiments. Variations are—among others—due to manual release of droplets and changes in positioning of the pipette above the light beam due to manual operation. Also at a vertical falling distance of 5 mm, different shapes of the droplet while falling through the beam are indicated by peaks with a shoulder.

Parameters for this experiment were:

| | |
|---|---|
| Dye: | Fluoresceine in 100 mM NaHCo₃ |
| | and 1 M NaOH |
| Volume: | 5 μl (droplet falling from |
| | pipette tip) |
| Distance sample to sensor: | 18 mm |
| Falling distance of droplet | 5 mm and 10 mm |
| to beam: | |
| Amplification factor: | 3 * 10⁹ |
| pH: | pH 8.5 and >12 pH |
| Ex/Em: | 470/>520 nm |
| Threshold for trigger: | 30 mV and 60 mV |
| Acquisition rate (scope mode): | 1.5 kHz |
| Exposure time: | millisecond range |

### Reflectrometric Measurements

Another example is in the field of binding of alpha-progesterone antibody to progesterone.

Analyte: alpha-Progesteron antibody binding to progesteron; Sample: isolated antibody in buffer, Sample Format: Surface, Target Family: Hormones/Small Molecules, Detection: one wavelength reflectrometric interference spectroscopic measurement (1-λ RIFS). Sensor/Optical surface thickness.

The concentration of alpha-Progesteron antibody was determined in a sample using a one wavelength interference spectroscopic measurement^{[3]} by binding it to progesterone bound to a surface. These measurements do not require any label. Therefore the antibody-antigen binding is not negatively affected. Additional advantages are cost efficiency and rapid results as no labelling steps need to be performed. The sample was pumped over a progesteron coated glass surface and the change in optical thickness of the surface was determined by shift in intensity at the selected wavelength over time (FIG. 19). The optical thickness changes when the analyte is captured on the surface. After about 8 to 10 minutes (600 sec) the test is conclusive. The technique provides accurate results being widely independent of temperature.

FIG. 19 shows label-free measurement (raw data) of 30 μg mL⁻¹ antibody (a-progesteron) with indicated exponential fits of k_{obs} (observable rate constant) and k_{d} (dissociation rate constant). This typical measurement of an antibody/antigen interaction shows in the beginning of the association phase a linear behavior because of mass transport limited conditions followed by a kinetically controlled phase (indicated by the red exponential fit) and a biexponential phase. The dissociation phase is indicated by the blue exponential fit.

1-47. (canceled)

48. Optical measuring instrument for investigating a specimen contained in a sample, comprising:
at least one source for providing at least one electromagnetic beam intended to irradiate the sample and to interact with the specimen within the sample;
at least one sensor for detecting an output of the interaction between the specimen and the electromagnetic beam;
an integrally formed mechanical bench formed in one piece for the optical and electronic components;
a sample holder for holding the sample;
the at least one source, the at least one sensor, and the mechanical bench are integrated in one monolithic optoelectronic module establishing a compact self-consistent unit;
the at least one source and the at least one sensor are arranged such that a confocal measurement can be performed, wherein confocal measurement means, that the focus of the illumination optics or the source, respectively, intrinsically is the same as the focus of the detection optics or sensor, respectively; and
construction of the monolithic module predefines the focus of the illumination optics and the focus of the detection optics to be the same in three dimensions, and the sample holder can be connected to this module.

49. Optical measuring instrument according to claim 48, wherein the module comprises an interface for connecting sample holders of different types for various sample formats.

50. Optical measuring instrument according to claim 48, wherein a monitor element is provided.

51. Optical measuring instrument according to claim 48, wherein said instrument is a handheld or mobile instrument.

52. Optical measuring device for investigating a specimen contained in a sample, comprising:
at least one source for providing at least one electromagnetic beam intended to irradiate the sample and to interact with the specimen within the sample;
at least one sensor for detecting an output of the interaction between the specimen and the electromagnetic beam;
an integrally formed mechanical bench formed in one piece for the optical and electronic components;
the at least one source, the at least one sensor, and the mechanical bench are integrated in one monolithic optoelectronic module establishing a compact self-consistent unit;
the at least one source and the at least one sensor are arranged such that a confocal measurement can be performed, wherein confocal measurement means, that the focus of the illumination optics or the source, respectively, intrinsically is the same as the focus of the detection optics or sensor, respectively; and
construction of the monolithic module predefines the focus of the illumination optics and the focus of the detection optics to be the same in three dimensions.

53. Optical measuring device according to claim 52, wherein the device is stackable.

54. Method for performing an optical measurement using an optical measurement device according to claim 52, comprising:
emitting an electromagnetic beam by the source to the sample to interact with the specimen within the sample; and
detecting an output of this interaction by the sensor, wherein the at least one source and the detector are arranged such that a confocal measurement is performed.

55. Method according to claims 54, wherein a luminescence measurement is performed.

56. Method according to claim 54, wherein a reflection or reflectrometric measurement is performed.

57. Method according to claim 54, wherein an absorption measurement is performed.

58. Method according to claim 54, wherein a densitometric measurement is performed.

59. Method according to claim 54, wherein ambient light compensation is carried out.

60. Method according to claim 54, wherein the specimen is contained within a liquid.

61. Method according to claim 54, wherein the specimen is contained within a solid.

62. Method according to claim 54, wherein the specimen is contained within a gel.

63. Method according to claim 54, wherein the specimen is contained within a droplet.

64. Method according to claim 54, wherein the specimen is contained within a liquid jet.

65. Method according to claim 54, wherein a calibration is periodically performed.
